(19) United States
(12) Patent Application Publication
(10) Pub. No.: US 2008/0159513 A1
(43) Pub. Date: Jul. 3, 2008

(54) SYSTEM AND METHOD FOR PROVIDING AUTOMATIC ALERTS OF NETWORK AVAILABILITY TO A FIXED COMMUNICATION DEVICE

(75) Inventor: Satish Kumar M. Mundra, Germantown, MD (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/962,721

(22) Filed: Dec. 21, 2007

Related U.S. Application Data
(60) Provisional application No. 60/877,264, filed on Dec. 27, 2006.

(51) Int. Cl. H04M 3/42

(52) U.S. Cl. 379/207.04

(57) ABSTRACT

A gateway includes a transceiver operable to transmit and receive communications to a fixed communication device, and a processor cooperatively operable with the transceiver. The processor is configured to facilitate during a non-alerting mode: detecting when a fixed communication device attempts to connect via the transceiver to a voice over packet (VOP) network service which is temporarily unavailable, and then switching to an alerting mode. Also, the processor is configured for, during the alerting mode: monitoring an availability of voice over packet (VOP) network service; when the VOP network service becomes available, causing the fixed communication device to provide an audible alert via the transceiver and switching to the non-alerting mode.

### CROSS-REFERENCE TO RELATED APPLICATIONS

This application claims the benefit of the U.S. Provisional Application No. 60/877,264 filed Dec. 27, 2006, which is expressly incorporated herein by reference.

### TECHNICAL FIELD

The technical field relates in general to communications between a residential gateway and a fixed communication device connected to the gateway for access to Internet telephony, and more specifically, to the provisioning of a protocol to provide enhanced functionality to fixed communication devices.

### BACKGROUND

Residential gateways (sometimes referred to as service gateways, home gateways, and access devices) are a key part of the home networking solution. They provide a platform for integrating different broadband access technologies and several home networking solutions. A residential gateway can connect a local area network (LAN) in a home to the Internet. A hardware device similar to a router, the residential gateway provides a unique combination of features.

By definition, a gateway joins two networks together. Gateway hardware exists in multiple forms including general-purpose servers with multiple network adapters and routers. Traditional gateways have been installed in server rooms or closets, but residential gateways bring these devices into the home. Home gateways vary significantly in their capabilities, so that no one “typical” home gateway exists. However, most residential gateways support some basic features, broadband (often DSL (digital subscriber line)) service connectivity, Internet connection sharing and firewall security. This connectivity can bring VoIP (voice over Internet protocol) into the local network, allowing the connection of a telephone system to VoIP through the gateway.

By connecting the home or small office network to the Internet, a residential gateway provides translation and allows access to a DSL or cable modem Internet connection. The residential gateway sits between the DSL or cable modem which downloads and uploads data, voice, and video, and provides Internet access and an internal network. Alternately, a DSL or cable modem might be integrated into the residential gateway.

### SUMMARY

Accordingly, one or more embodiments provide a gateway. The gateway includes a transceiver operable to transmit and receive communications to a fixed communication device; and a processor cooperatively operable with the transceiver. The processor is configured to facilitate during a non-alerting mode: detecting when a fixed communication device attempts to connect via the transceiver to a voice over packet (VOP) network service which is temporarily unavailable, and then switching to an alerting mode. Also, the processor is configured for, during the alerting mode: monitoring an availability of voice over packet (VOP) network service; when the VOP network service becomes available, causing the fixed communication device to provide an audible alert via the transceiver and switching to the non-alerting mode.

Other embodiments provide a computer-readable medium comprising instructions being executed by a computer, the instructions including a computer-implemented method for alerting a user upon voice over packet (VOP) network availability to a fixed communication device over a gateway. The instructions provide during a non-alerting mode: detecting when a fixed communication device attempts to connect over the gateway to a voice over packet (VOP) network service which is temporarily unavailable, and then switching to an alerting mode. The instructions also provide, during the alerting mode: monitoring an availability of voice over packet (VOP) network service; when the VOP network service becomes available, causing the fixed communication device to provide an audible alert and switching to the non-alerting mode.

Accordingly, one or more embodiments provide a gateway. The gateway includes a transceiver operable to transmit and receive communications to a fixed communication device; and a processor cooperatively operable with the transceiver. The processor is configured to facilitate during a non-alerting mode: detecting when a fixed communication device attempts to connect via the transceiver to a voice over packet (VOP) network service which is temporarily unavailable, and then switching to an alerting mode. Also, the processor is configured for, during the alerting mode: monitoring an availability of voice over packet SOP) network service; when the VOP network service becomes available, causing the fixed communication device to provide an audible alert via the transceiver and switching to the non-alerting mode.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a diagram illustrating a simplified and representative environment associated with a fixed communication device and a gateway;

FIG. 2 is a diagram illustrating portions of a gateway;

FIG. 3 is a block diagram illustrating portions of a MDMF (multiple data message format) message;

FIG. 4 is a state diagram illustrating alerting and non-alerting modes; and

FIG. 5 is a flow chart illustrating an exemplary procedure for providing alerting upon voice over packet (VOP) network availability.

### DETAILED DESCRIPTION

In overview, the present disclosure concerns gateways and fixed communication devices which are configured to connect together, and wherein a gateways are further connected between fixed communication devices and communication networks, often referred to as voice over packet (VOP) networks, such as may be associated with networks supporting voice communication. Such communication networks may provide additional services such as data communications, signal, and/or video services. Such communication networks can include network infrastructure devices which transfer the communications between endpoints, for example by forwarding the communications which may have been broken into communication packets and may be reassembled. More particularly, various inventive concepts and principles are embodied in systems, devices, and methods therein for providing an alert at a fixed communication device that the VOP network is available following a temporary service outage.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

A user is typically denied dial-tone when calls cannot be made for reasons such as firmware/hardware upgrade of network elements, problems in the home network, problems in the Internet service provider (ISP) network or problems in the voice service provider (VSP) network. Under these conditions, a user with a conventional gateway will not know when the service returns from the temporary outage and either has to periodically go off-hook and check the status or monitor the visual indicators available. This can be an irritating experience, especially if making a call is important to the user.

As further discussed herein below, various inventive principles and combinations thereof are advantageously employed so that a fixed communication device is caused to provide an audible alert, if an off-hook or call-attempt is detected during service outage, and thereafter the audible alerting is activated, relieving the user from the burden of visual monitoring or periodic checks for availability of service by going off-hook. The alerting can alternatively be activated by dialing a feature code, similar to the activation/deactivation of a supplementary service.

A communication protocol for phones attached to VoIP gateways provides for enhanced communication between a phone which can only communicate with DTMF signals and a residential gateway which provides access to the Internet. Using FSK and/or DTMF signaling, the present disclosure provides phone access to a set of IP phone capabilities which can include advanced dialing, visual display of device configuration and/or user alert on service availability after a break in service. A conventional residential gateway used for VoIP presents a barrier to the flow of additional and enhanced telephony information. VoIP signaling protocols such as SIP, used by IP phones and software phones, provide enhanced capabilities which are enabled for the telephone by the present disclosure. The present disclosure also allows for automated notification of interruption and restoration of service.

Further in accordance with exemplary embodiments, a gateway is provided with the ability to monitor network conditions under which call completion is not possible and can indicate the service unavailability by substituting the dial-tone with, for example, silence, an error tone, or playing a local announcement, which can be readily utilized with a conventional fixed communication device such as a typical home phone.

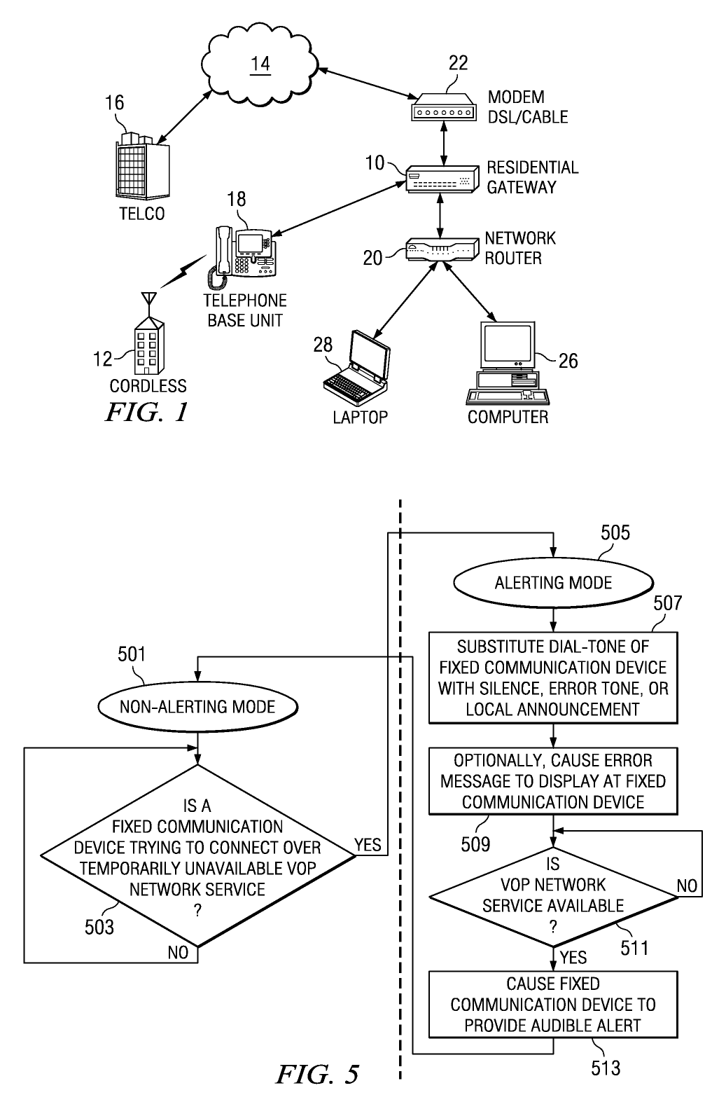

Referring now to FIG. 1, a diagram illustrating a simplified and representative environment associated with a fixed communication device and a gateway will be discussed and described. The illustration of FIG. 1 includes a typical residential gateway (RGW) interconnection. The residential gateway 10, if used for telephony, such as VoIP, will connect to a home phone 12, and connect the home phone 12 to the Internet 14, for example through a modem 22. Although a residential gateway 10 provides connectivity, when used for VoIP, a residential gateway 10 traditionally presents a barrier to the flow of additional and enhanced telephony information from the telco central office 16 to the residential phone 12. A residential gateway 10, although connected to the Internet 14 and able to communicate with other parties, does not readily pass any information through to the telephone 12, which acts like a POTS (plain old telephone service) phone and only receives limited data, such as telephone numbers.

Further, conventional residential gateways do not provide automatic alerting when VoIP service becomes available after a service interruption. A user is typically denied dial-tone when calls cannot be made for reasons such as upgrade of network elements, problems in the home network, problem in the ISP (Internet service provider) network or problems in the VSP (Voice service provider) network. An intelligent gateway can monitor the network conditions under which call completion is not possible and indicates the service unavailability by substituting the dial-tone with silence, an error tone, or playing a local announcement. Thus the user knows, when attempting to dial, that service is unavailable. However, unless the user periodically checks for a dial tone, the user will not know when service is again available. Under these conditions, the user will only know that service is unavailable by checking the equipment and will not know when the service has returned from temporary outage and either has to periodically go off-hook and check the status or monitor the visual indicators available. This can be an irritating experience, especially if the making the call is important to the user.

The issues listed above are some examples and by no means an exhaustive list of limitations that the inventors have noted which conventional RGW users experience even while using a VoIP network infrastructure.

When service is interrupted, and an off-hook or call-attempt is detected during service outage and only then the audible alerting mechanism is activated, reliving the user from the burden of visual monitoring or periodic checks for availability of service by going off-hook. In addition to automatic activation, this mechanism can also be activated by dialing a feature code, similar to the activation/deactivation of a supplementary service.

In addition to the elimination of repeated checking for service restoration, automatic notification of service re-availability reduces the need for service providers to provide notification of planned or unplanned service outage. This feature also improves out of box experience for new customers as the device needs to go through possible firewall (FW) upgrades, provisioning, proper cabling before the dial-tone is available.

The automated service restoration notification mechanism taught herein is activated only if an off-hook or call-attempt is detected during service outage and only then the audible alerting mechanism is activated. In addition to automatic activation, this mechanism can also be activated by dialing a feature code, similar to the activation/deactivation of a supplementary service.

Accordingly, one or more embodiments provide a device, method, and computer-readable medium for alerting a user upon voice over packet (VOP) network availability to a fixed communication device over a gateway.

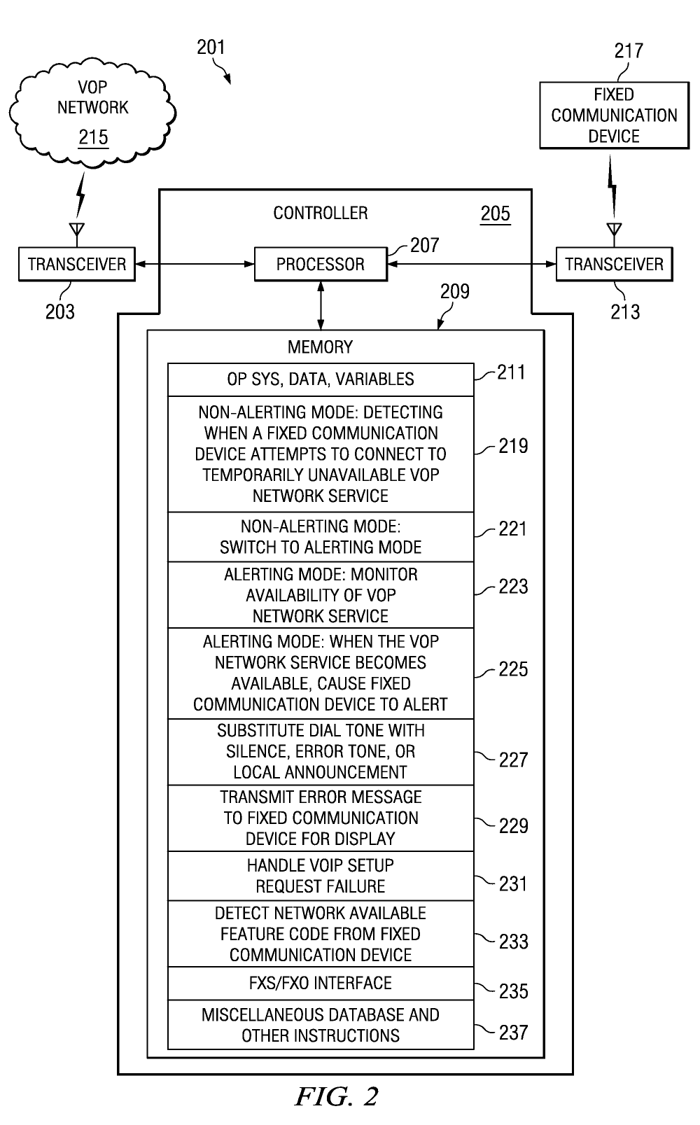

Referring now to FIG. 2, a diagram illustrating portions of a gateway will be discussed and described. The gateway 201 may include a first transceiver 203 for communicating over a communication network, here represented by a VOP network 215, a second transceiver 213 for communicating with a fixed communication device 217, and one or more controllers 205. The first transceiver 203 is representative of a combination of any number of transmitters and/or receivers, and may have a wireless or wired connection to the VOP network 215. Also, the second transceiver 213 can be representative of a combination of transmitters and/or receivers and may have a wireless or wired connection to the fixed communication device 217.

The controller 205 may include a processor 207, a memory 209, and other optional components which will be well understood to those in this field. A display, a keyboard, and/or other display and input device for interacting with the user, such as a track ball, console, keypad, and/or similar optionally can be provided with the gateway 201.

The processor 207 may be, for example, one or more microprocessors and/or one or more digital signal processors. The memory 209 may be coupled to the processor 207 and may comprise a read-only memory (ROM), a random-access memory (RAM), a read/write flash memory, a programmable ROM (PROM), and/or an electrically erasable read-only memory (EEPROM). The memory 209 may include multiple memory locations for storing, among other things, an operating system, data and variables 211 for programs executed by the processor 207; computer programs for causing the processor to operate in connection with various functions in connection with a non-alerting mode and an alerting mode, substituting 227 a dial tone with silence, error tone, or local announcement, transmitting 229 an error message to the fixed communication device for display, detecting 233 a network available feature code received from the fixed communication device; and a database 237 of various information and other instructions used by the processor 207. The non-alerting mode functions stored in the memory 209 can include detecting 219 when a fixed communication device attempts to connect to temporarily unavailable VOP network service and switching 221 to the alerting mode. The alerting mode functions stored in the memory 209 can include monitoring 223 availability of VOP network service, and when 225 the VOP network service becomes available, causing the fixed communication device to alert. Conventional techniques can be used with an FXS/FXO interface 235 to establish the FXS/FXO connection to the fixed communication device 217. The computer programs may be stored, for example, in ROM or PROM and may direct the processor 207 in controlling the operation of the gateway 201. Each of these computer programs is discussed by way of example below.

The processor 207 may be programmed for, in the non-alerting mode, detecting 219 when a fixed communication device attempts to connect to a temporarily unavailable VOP network service. More particularly, the processor 207 can detect that the fixed communication device has initiated a connection to the VOP network 215 according to conventional techniques, for example, by dial an outgoing call via the controller 201, to go over the VOP network 215. As is known, the fixed communication device 217 can initiate the connection by sending an off-hook indication or call attempt indication in accordance with the second transceiver 213.

Accordingly, one or more embodiments provides that the attempt to connect is detected if an off-hook or a call attempt is received from the fixed communication device. Embodiments also provide that the detecting of the attempt to connect comprises receiving from the fixed communication device, in accordance with the transceiver, an off-hook indication.

In direct response to the initiated connection, the processor 207 attempts to connect to the VOP network 215 over the first transceiver 203. More particularly, the processor 207 can request a VoIP setup, which is a standard call to the VoIP protocol processor to initiate a VoIP setup. If the VOP network 215 is unavailable for reasons include firmware/hardware upgrade of network elements, problems in a home network, problems in the Internet service provider (ISP) network, and/or problems in the voice service provider (VSP) network, a VoIP setup request failure is returned to and handled by the processor 207. Upon receipt of the VoIP setup request failure, the VOP network is determined to be temporarily unavailable.

Accordingly, one or more embodiments provides that the network is determined to be temporarily unavailable by handling a VoIP setup request failure.

Also, the processor 207 may be programmed for, in the non-alerting mode, switching 221 to the alerting mode. The switch to alerting mode is made when the VOP network is determined to be temporarily unavailable, more particularly when the unavailability is discovered as a direct result of a fixed communication device 217 initiating a connection to the VOP network 215 as discussed above. Because the unavailability of the VOP network 215 is not known until the connection is initiated by the fixed communication device 217, the alert when the VOP network 215 later becomes available is therefore issued only to a user who is potentially interested in receiving the alert. That is, a temporary unavailability of the VOP network 215 when no attempt has been made to dial over the VOP network is transparent and does not result in the alert being issued.

Further, the processor 207 can be programmed for, in the alerting mode, monitoring 223 availability of VOP network service. For example, when in the alerting mode, the processor 207 can periodically request VoIP setup to return a VoIP setup request failure or success, thereby checking whether the VOP network service is available or unavailable.

Additionally, the processor 207 can be programmed so that, when in the alerting mode and when the VOP network service becomes available, causing 225 the fixed communication device to alert. Accordingly, when it is determined while in alerting mode that the VOP network service is available, the processor 207 communicates with the fixed communication device 217 over the transceiver 213, to cause the fixed communication device 217 to issue an alert. More particularly, the alert can be audible, haptic, and/or visual. As an example of an audible alert, the processor 207 can cause the fixed communication device 217 to ring, in accordance with known techniques for ringing the fixed communication device. For the haptic alert, the processor 207 can cause the fixed communication device 217 to vibrate, in accordance with known techniques for vibrating the fixed communication device. Similarly, if a visual alert is available at the fixed communication device 217, the processor 207 can cause the fixed communication device 217 to visually alert in accordance with known techniques. The audible, visual, and/or haptic alerts can be used alone or in any combination with each other. When the fixed communication device has been caused to alert, the processor 207 switches back to the non-alerting mode. Optionally, a predetermined number of multiple consecutive alerts can be caused, or alerts can be issued for a pre-defined period of minutes, prior to switching to the non-alerting mode.

The processor 207 further can be programmed for substituting 227 a dial tone with silence, error tone, or local announcement. The substituting can be done during the alerting mode, to indicate that the VOP network service is temporarily unavailable. The substituting of the dial tone with the error tone or silence can be performed by manipulating the FXS/FXO interface 235 to the fixed communication device 217 in accordance with known techniques. The substituting of the dial tone with the local announcement can be performed by transmitting the announcement to the fixed communication device 217 in accordance with known techniques, so that the local announcement is played at the fixed network device 217. Consequently, a user attempting to dial over the VOP network 215 when VOP network service is unavailable (during alerting mode) will be immediately aware that there is a problem with the VOP network service, without needing to wait for a failure of the dial attempt.

Accordingly, embodiments provide for, during the alerting mode, indicating that the VOP network service is temporarily unavailable by causing the dial-tone of the fixed communication device to be substituted with silence or an error tone by manipulating the FXS/FXO interface to the fixed communication device. Further accordingly, embodiments provide for, during the alerting mode, indicating that the VOP network service is temporarily unavailable by causing the dial-tone of the fixed communication device to be substituted with a local announcement.

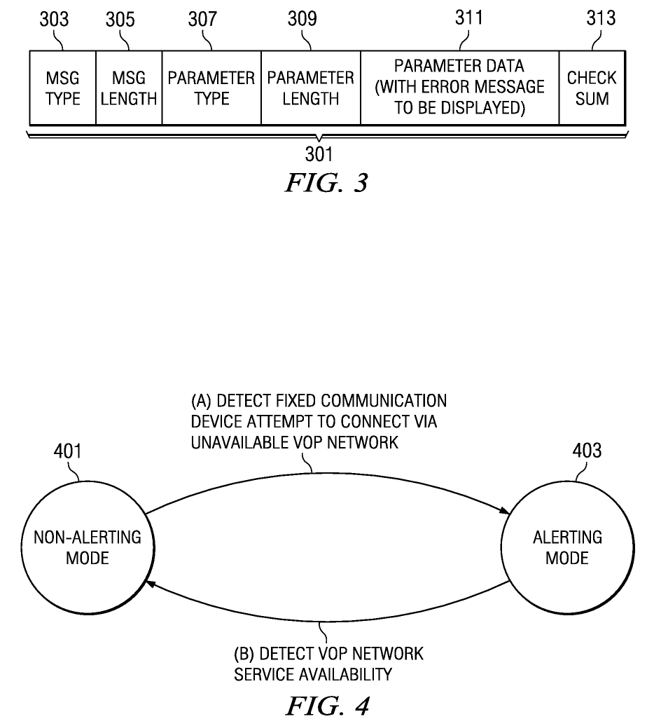

Also, the processor 207 can be programmed for transmitting 229 an error message to the fixed communication device for display. The error message can be transmitted to the fixed communication device 217 in accordance with known techniques, so that the error message is displayed at the fixed network device 217. For example, a multiple data message format (MDMF) message can be sent from the processor 207 to the fixed communication device 217 via the second transceiver 213, with the error message embedded in the MDMF message. An illustration of an appropriate MDMF message is discussed in more detail connection with FIG. 3.

The processor 207 can include programming for detecting 233 a network available feature code received over the second transceiver 213 from the fixed communication device 217. The network available feature code can be a pre-defined feature code, as in the manner of the activation/deactivation of a supplementary service. Such feature codes typically begin with a humphry (e.g., a “*” or “#”) and are followed by two digits. Thus, in addition to the automatic activation of the audible alerting mechanism, the audible alerting can be expressly initiated by the network available feature code, whereby alerting mode begins if the VOP network is temporarily unavailable. Optionally, alerting mode can be deactivated by entry of the pre-defined feature code (as in the manner of a toggle) or a different pre-defined feature code (to deactivate the feature), whereby non-alerting mode begins.

Moreover, a computer-readable medium may include instructions for execution by a computer, the instructions including a computer-implemented method for alerting a user upon voice over packet network availability to a fixed communication device.

Also illustrated is the miscellaneous database 237 of various information used by the processor 207. The database 231 is provided for local storage of information. For example, the database 231 can be used for storing the local announcements and/or the error messages to be provided to the fixed communication device 217.

It should be understood that various embodiments are described herein in connection with logical groupings of functions. One or more embodiments may omit one or more of these logical groupings. For example, embodiments may omit the substituting 227 of the dial tone with silence, error tone or local announcement; the transmitting 229 of an error message to the fixed communication device; and/or detecting 233 the network available feature code. Likewise, in one or more embodiments, functions may be grouped differently, combined, or augmented.

Accordingly, one or more embodiments provides a gateway, including a transceiver operable to transmit and receive communications to a fixed communication device; and a processor cooperatively operable with the transceiver. The processor can be configured to facilitate (i) during a non-alerting mode: detecting when a fixed communication device attempts to connect via the transceiver to a voice over packet (VOP) network service which is temporarily unavailable, and then switching to an alerting mode; and (ii) during the alerting mode: monitoring an availability of voice over packet (VOP) network service; and when the VOP network service becomes available, causing the fixed communication device to provide an audible alert via the transceiver and switching to the non-alerting mode.

Referring now to FIG. 3, a block diagram illustrating portions of a MDMF message will be discussed and described. A message 301 in MDMF format includes a message type 303, a message length 305, a parameter type 307 (here, caller ID), a parameter length 309, a parameter data field 311 (here, containing a local announcement) and a check sum 311. Other fields may be included, as is known. Conveniently, the local announcement can be included in a MDMF format message that uses a conventional caller ID parameter type 307. Upon receiving a MDMF format message with a caller ID parameter type 307, a fixed communication device displays the contents of the parameter data field 311 as ACSII data. The local announcement that is inserted in the parameter data field 311 can conveniently be formatted by the gateway as ASCII data.

Accordingly, one or more embodiments provide for, during the alerting mode, indicating that the VOP network service is temporarily unavailable by causing an error message to be displayed at the fixed communication device by transmitting the error message to the fixed communication device as a multiple data message format (MDMF) message.

Referring now to FIG. 4, a state diagram illustrating alerting and non-alerting modes will be discussed and described. The state diagram includes two states: non-alerting mode state 401 and alerting mode state 403.

In the non-alerting mode state 401, there is no need to provide an alert to the fixed communication device regarding network availability; VOP network availability is not monitored. In the alerting mode state 403, the availability of the VOP network is monitored and an alert is provided to the fixed communication device when the network becomes available.

Two events are recognized, which can cause a change of state. The events are (A) detecting a fixed communication device attempt to connect via an unavailable VOP network, and (B) detecting VOP network service availability. Event (A) causes the non-alerting mode state 401 to change to the alerting mode state 403. Event (B) causes the alerting mode state 403 to change to the non-alerting mode state 401.

In addition, a transition from the alerting mode state 403 to the non-alerting mode state 401 includes providing the alert to the fixed communication device. The is, when the state is in the alerting mode state 403 and the VOP network service availability event is detected, the alert is then provided to the fixed communication device (to notify a user the VOP network service has become available), and the state is changed to the non-alerting mode state 401.

Accordingly, one or more embodiments provides for states including a non-alerting mode and an alerting mode. During a non-alerting mode: the embodiment can detect when a fixed communication device attempts to connect via the transceiver to a voice over packet (VOP) network service which is temporarily unavailable, and then switch to an alerting mode. During the alerting mode, the embodiment can monitor an availability of voice over packet (VOP) network service; and when the VOP network service becomes available, cause the fixed communication device to provide an audible alert via the transceiver and switch to the non-alerting mode.

Referring now to FIG. 5, a flow chart illustrating an exemplary procedure for providing alerting upon voice over packet (VOP) network availability will be discussed and described. The procedure can advantageously be implemented on, for example, a processor of a controller, described in connection with FIG. 2 or other apparatus appropriately arranged.

In overview, the procedure includes non-alerting mode 501 and alerting mode 505. In non-alerting mode 501, the procedure checks 503 whether the fixed communication device is attempting to connect over a temporarily unavailable VOP network service. If the connection was attempted over the unavailable VOP network service, the procedure switches to alerting mode 505. In alerting mode 505, the procedure substitutes 507 dial-tone with silence, an error tone, or a local announcement; causes 509 an error message to be displayed; checks 511 whether the VOP network service is available, and if so causes 513 the audible alert at the fixed communication device and switches to non-alerting mode 501. Each of these is discussed below, however some details that were discussed are omitted for clarity.

In non-alerting mode 501, the procedure checks 503 whether the fixed communication device is attempting to connect over a temporarily unavailable VOP network service. The detection that a fixed communication device is attempting to connect over a VOP network service, and the determination that the VOP network service is unavailable have both been discussed above in more detail. The non-alerting mode 501 continues to repeat the check 503 until the connection was attempted over the unavailable VOP network service.

If the connection was attempted over the unavailable VOP network service, the procedure switches to alerting mode 505. In alerting mode 505, the procedure will provide an alert to notify the user once the VOP network service becomes available, and will then switch back to non-alerting mode 501.

In alerting mode 505, the procedure substitutes 507 the dial-tone of the fixed communication device with silence, an error tone, or a local announcement. That is, the procedure causes the fixed communication device to be silent to provide an error tone, or to play a local announcement, during the times when the fixed communication device conventionally would be playing a dial-tone. Techniques have been discussed above for use of FXS/FXO mechanisms and/or similar to substitute the dial-tone.

Optionally, in alerting mode 505, the procedure causes 509 an error message to be displayed at the fixed communication device. A MDMF message containing the error message can be sent by the procedure to the fixed communication device, as discussed above in more detail, to cause the fixed communication device to display the error message.

Further in alerting mode 505, the procedure checks 511 whether the VOP network service is available. The procedure loops to periodically check 511 whether the VOP network service is available. Techniques for the checking were discussed in greater detail above. If the VOP network service is available, the procedure causes 513 the fixed communication device to provide an alert, such as an audible alert (as discussed above in more detail). Having alerted the user, the procedure switches to non-alerting mode 501.

Accordingly, one or more embodiments provides a computer-implemented method for alerting a user upon voice over packet (VOP) network availability to a fixed communication device over a gateway, using the non-alerting mode and the alerting mode as discussed above.

An example use of the procedure is now discussed. A user at a fixed communication device dials a gateway running the procedure of FIG. 5. The procedure on the gateway is initially in the non-alerting mode 501. So long as the VOP network service is available when the fixed communication device dials the gateway, the procedure remains in the non-alerting mode 501.

If while in non-alerting mode, however, the user dials and an attempted connection from the gateway to the VOP network service fails, then the procedure on the gateway switches to alerting mode 505. If the fixed communication device is still playing dial-tone, then the dial-tone is substituted 507 with silence, an error tone, or a local announcement. Presumably the user then hangs up the fixed communication device. The optional error message 509 can also be displayed at the fixed communication device. The user is now awaiting an alert to indicate when the VOP network service becomes available once again. Because the alert will be provided, it is not necessary for the user to carry out the frustrating and time-consuming tasks of continually checking if VOP network service has become available by continually attempting to dial. If the user wishes to cancel the alerting mode, optionally, the user can enter the pre-determined feature code.

While in the alerting mode, the procedure at the gateway continually checks 511 whether the VOP network service is available. Once it detects availability of the VOP network service, the gateway running the procedure causes 513 the fixed communication device to provide the alert, such as an audible, haptic, or visual alert. The procedure then switches back to non-alerting mode 501. The user can hear, feel or see the alert, and can then proceed to dial and communicate from the fixed communication device over the VOP network service in the usual manner.

The term “FSK” as used herein is intended to indicate various Frequency Shift Keying (FSK) standards used in various countries across the globe, including the ETSI FSK (European Telecommunications-1 and -2, ES 200 778-1 and -2, ETS 300 778-1 and -2), Bellcore FSK, BT (British Telecom) FSK and CCA (Cable Communication Association) FSK, and variations and evolutions thereof.

The term “MDMF” is used herein to indicate multiple data message format standards, for example, the presentation message format as described in the European Telecommunications Standard ETS 300 659-1, and variations and evolutions thereof, which is for example used in connection with fixed communication device line protocol.

The term “fixed communication device” as used herein specifically means a telephone handset device that operates in accordance with FXS/FXO procedures, sometimes referred to as a two-wire telephone, a residential phone, or a local phone, where the handset can be connected by a telephone line cord or wirelessly, directly or indirectly (such as via a base station) as an FXO device to the gateway operating as an FXS device, in accordance with known FXS/FXO connection techniques. Such a device can generate DTMF. The term “fixed communication device” as used herein does not encompass cellular communication device capability, such as where the cellular communication device is associated with a subscriber on a cellular communication network.

The term “gateway” is used above in the detailed description and in the claims to specifically mean any of various network devices providing or communicating on VOP networks, that is, a hardware device connecting an internal network with a wide area network (WAN) or the Internet. The gateway can provide network address translation so as to allow the computers in the internal network to share one IP address and Internet connection and Internet connection, and can combine the functions of an IP router, multi-port Ethernet switch and/or wireless access point; the gateway may be located between the modem and the internal network, or a DSL or cable modem may be integrated into the gateway. The gateway can incorporate various proprietary devices and/or devices which are the subject of standardization efforts such as the Home Gateway Initiative (HGI), and the like, and variants or evolutions thereof. Such devices are sometimes colloquially referred to as “residential gateways,” “home gateways,” “home routers,” or “broadband routers.” The designation “VoIP gateway” is used herein to indicate such a gateway specifically including functionality to communicate using VoIP.

It should be noted that the term “network infrastructure device” denotes a device or software that receives communications via a communication network (as described below), determines a next network point to which the communications should be forwarded toward their destinations, and then forwards the communications. Typically the network infrastructure device is assigned a unique Internet protocol (IP) address. Examples of network infrastructure devices include devices and/or software which are sometimes referred to as routers, edge routers, switches, bridges, brouters, gateways, home gateways, media gateways, centralized media gateways, session border controllers, trunk gateways, call servers, hubs, and the like, and variants or evolutions thereof.

Furthermore, the communication networks of interest include those that transmit information in packets, for example, those known as packet switching networks, more particularly using VOP (voice over packet) protocol, and even more particularly using VoIP (voice over IP) protocol, and even more particularly using SIP-formatted packets. Such networks can include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability and/or utilize wireline connections such as cable and/or a connector, or similar.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A gateway, comprising:
a transceiver operable to transmit and receive communications to a fixed communication device; and
a processor cooperatively operable with the transceiver, the processor being configured to facilitate
during a non-alerting mode:
detecting when a fixed communication device attempts to connect via the transceiver to a voice over packet (VOP) network service which is temporarily unavailable, and then switching to an alerting mode;
during the alerting mode:
monitoring an availability of voice over packet (VOP) network service;
when the VOP network service becomes available, causing the fixed communication device to provide an audible alert via the transceiver and switching to the non-alerting mode.

2. The gateway of claim 1, further comprising, during the alerting mode, indicating that the VOP network service is temporarily unavailable by causing the dial-tone of the fixed communication device to be substituted with silence or an error tone by manipulating the FXS/FXO interface to the fixed communication device.

3. The gateway of claim 1, her comprising, during the alerting mode, indicating that the VOP network service is temporarily unavailable by causing the dial-tone of the fixed communication device to be substituted with a local announcement.

4. The gateway of claim 1, further comprising, during the alerting mode, indicating that the VOP network service is temporarily unavailable by causing an error message to be displayed at the fixed communication device by transmitting the error message to the fixed communication device as a multiple data message format (MDMF) message.

5. The gateway of claim 1, wherein the attempt to connect is detected if an off-hook or a call attempt is received from the fixed communication device.

6. The gateway of claim 1, wherein the detecting of the attempt to connect comprises receiving from the fixed communication device, in accordance with the transceiver, an off-hook indication.

7. The gateway of claim 1, wherein the VOP network services determined to be temporarily unavailable by handling a VoIP setup request failure.

8. A computer-readable medium comprising instructions being executed by a computer, the instructions including a computer-implemented method for alerting a user upon voice over packet (VOP) network availability to a fixed communication device over a gateway, the instructions for implementing:
during a non-alerting mode:
detecting when a fixed communication device attempts to connect over the gateway to a voice over packet (VOP) network service which is temporarily unavailable, and then switching to an alerting mode;
during the alerting mode:
monitoring an availability of voice over packet (VOP) network service;
when the VOP network service becomes available, causing the fixed communication device to provide an audible alert and switching to the non-alerting mode.

9. The computer readable medium of claim 8, further comprising, during the alerting mode, indicating that the VOP network service is temporarily unavailable by causing the dial-tone of the fixed communication device to be substituted with silence or an error tone by manipulating the FXS/FXO interface to the fixed communication device.

10. The computer readable medium of claim 8, further comprising, during the alerting mode, indicating that the VOP network service is temporarily unavailable by causing the dial-tone of the fixed communication device to be substituted with a local announcement.

11. The computer readable medium of claim 8, further comprising, during the alerting mode, indicating that the VOP network service is temporarily unavailable by causing an error message to be displayed at the fixed communication device by transmitting the error message to the fixed communication device as a multiple data message format (MDMF) message.

12. The computer-readable medium of claim 8, wherein the attempt to connect is detected if an off-hook or a call attempt is received from the fixed communication device.

13. The computer-readable medium of claim 8, wherein the detecting of the attempt to connect comprises receiving from the fixed communication device, in accordance with the transceiver, an off-hook indication.

14. The computer-readable medium of claim 8, wherein the VOP network service is determined to be temporarily unavailable by handling a VoIP setup request failure.

15. A computer-implemented method for alerting a user upon voice over packet (VOP) network availability to a fixed communication device over a gateway, comprising:
during a non-alerting mode:
detecting when a fixed communication device attempts to connect over the gateway to a voice over packet (VOP) network service which is temporarily unavailable, and then switching to an alerting mode;
during the alerting mode:
monitoring an availability of voice over packet (VOP) network service;
when the VOP network service becomes available, causing the fixed communication device to provide an audible alert and switching to the non-alerting mode.

16. The method of claim 15, further comprising, during the alerting mode, indicating that the VOP network service is temporarily unavailable by causing the dial-tone of the fixed communication device to be substituted with silence or an error tone by manipulating the FXS/FXO interface to the fixed communication device.

17. The method of claim 15, further comprising, during the alerting mode, indicating that the VOP network service is temporarily unavailable by causing the dial-tone of the fixed communication device to be substituted with a local announcement.

18. The method of claim 15, further comprising, during the alerting mode, indicating that the VOP network service is temporarily unavailable by causing an error message to be displayed at the fixed communication device by transmitting the error message to the fixed communication device as a multiple data message format (MDMF) message.

19. The method of claim 15, wherein the attempt to connect is detected if an off-hook or a call attempt is received from the fixed communication device.

20. The method of claim 15, wherein the detecting of the attempt to connect comprises receiving from the fixed communication device, in accordance with the transceiver, an off-hook indication.
